(19) United States
(12) Patent Application Publication
(10) Pub. No.: US 2004/0197523 A1
(43) Pub. Date: Oct. 7, 2004

(54) Multi-layered rain shield/golf towel

(76) Inventor: Peter M. Doty, New Port Richey, FL (US)

Correspondence Address: VINCENT J. VASTA, JR., ESQ., LAW OFFICES OF VINCENT J. VASTA, JR., PO BOX 494, NEW CANAAN, CT, 06840-0494, US

(21) Appl. No.: 10/407,545

(22) Filed: Apr. 4, 2003

(51) Int. Cl. B32B 3/06

(52) U.S. Cl. 428/99

(57) ABSTRACT

The present invention concerns a multi-layered combination rain shield and golf towel which incorporates a conventional golf towel layer with an additional fabric layer, which additional fabric layer is capable of shedding rain, into a combined item which can be used as either a golf towel or a rain shield, wherein the golf towel layer and the rain shield layer are commensurate in length and width and the two layers are attached along their respective perimeters by a means which permits the layers to be easily detached so that the golf towel may be cleaned separately by conventional means.

### FIELD OF THE INVENTION

The present invention relates to a multi-layered combination rain shield and golf towel which incorporates a conventional golf towel layer with an additional fabric layer, which additional fabric layer is capable of shedding rain, into a combined item which can be used as either a golf towel or a rain shield. More particularly, the present invention relates to a multi-layered combination rain shield and golf towel, wherein the golf towel layer and the rain shield layer are commensurate in length and width and the two layers are attached along their respective perimeters by a means which permits the layers to be easily detached so that the golf towel may be cleaned separately by conventional means.

### BACKGROUND OF THE INVENTION

Golf towels are a well-known accoutrement to the game of golf and have found acceptance as a very useful accompaniment by the well-equipped golfer. Most golfers have found themselves at one time or another in need of temporary protection from a sudden rain storm and for that reason golfers also often carry a rain poncho or other rain gear with them as they go forth to pursue their game.

The present invention provides for a very useful enhancement to the utility of a conventional golf towel, which is absorbent of water, by providing a water impervious layer in combination with such golf towel, which layer is capable of shedding water. The combined multi-layered rain shield/golf towel can therefore alternatively function as either a conventional golf towel or, by flipping it over, as a convenient rain shield to prevent the golfer and/or his or her equipment from being soaked by a sudden rain storm.

The Applicant is not aware of any prior art reference which is directed to a combination rain shield/golf towel such as is described and claimed in the present invention, nor is the Applicant aware of any prior art reference which is directed to the totality of Applicant's combination, or its use and function in the manner described and claimed herein.

### OBJECTS OF THE INVENTION

It is, therefore, an object of the present invention to provide a multi-layered rain shield and golf towel.

It is another object of the present invention to provide for a multi-layered rain shield and golf towel, wherein the rain shield layer and towel layer are commensurate in length and are attached along their respective perimeters.

It is yet another object of the present invention to provide for a multi-layered rain shield and golf towel, wherein the rain shield layer and the golf towel layer are attached along their respective perimeters by a means which permits the layers to be easily detached.

Lastly, it is an object of the present invention to provide a multi-layered rain shield and golf towel which provides the user which a convenient means of preventing exposure to a sudden rain storm, while at the same time having the availability and advantages of a conventional golf towel.

These and other objects of the invention will become apparent from the following discussion of the invention.

### SUMMARY OF THE INVENTION

The present invention provides for a multi-layered combination rain shield and golf towel which incorporates a conventional golf towel layer with an additional fabric layer, which additional fabric layer is capable of shedding rain, into a combined item which can be used as either a golf towel or a rain shield. More particularly, the present invention relates to a multi-layered combination rain shield and golf towel, wherein the golf towel layer and the rain shield layer are commensurate in length and width and the two layers are attached along their respective perimeters by a means which permits the layers to be easily detached so that the golf towel may be cleaned separately by conventional means.

The construction and obvious advantages of the system provided for by the present invention will be more clearly understood from the following description of the various specific embodiments when read in conjunction with the accompanying drawings.

### BRIEF DESCRIPTION OF THE DRAWINGS

FIG. 1 is a three dimensional isometric view of the combination rain shield/golf towel of the invention showing the assembled combination.

FIG. 2 is a cross sectional view “a-a” of the combination rain shield/golf towel of the invention showing the layers and means of attachment for the combination shown in FIG. 1.

FIG. 3 is a expanded view of the attachment means used in the combination shown in FIG. 1.

### DETAILED DESCRIPTION OF THE INVENTION

The present invention is directed to a multi-layered combination rain shield and gold towel which incorporates a conventional golf towel layer with an additional fabric layer, which additional fabric layer is capable of shedding rain, into a combined item which can be used as either a golf towel or a rain shield. More particularly, the present invention relates to a multi-layered combination rain shield and golf towel, wherein the golf towel layer and the rain shield layer are commensurate in length and width and the two layers are attached along their respective perimeters by a means which permits the layers to be easily detached so that the golf towel may be cleaned separately by conventional means.

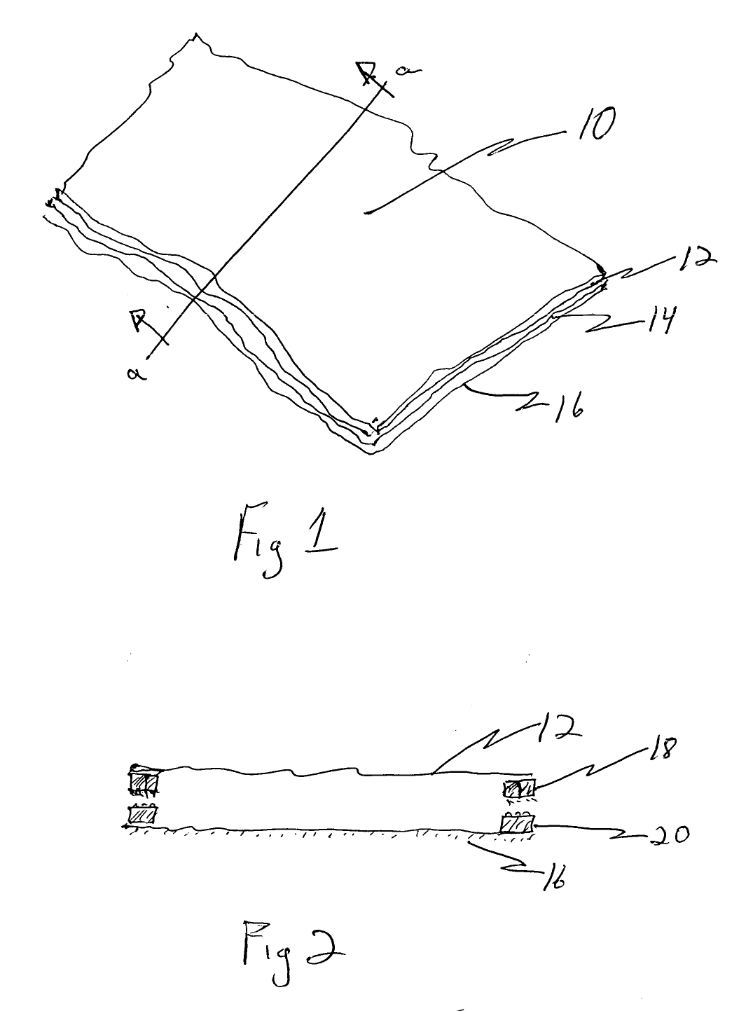

With reference to FIG. 1, shown are the rain shield/golf towel combination 10 with the rain shield surface constituting the top layer 12 and the golf towel constituting the bottom layer 16. The top layer 12 and the bottom layer 16 are joined along their respective perimeters using a continuous mating velcro type closure means 14. The combination 10 is provided with grommet holes 30, located in diagonally opposite corners of the combination to provide a means of attachment of the combination to the golfer's golf bag or cart.

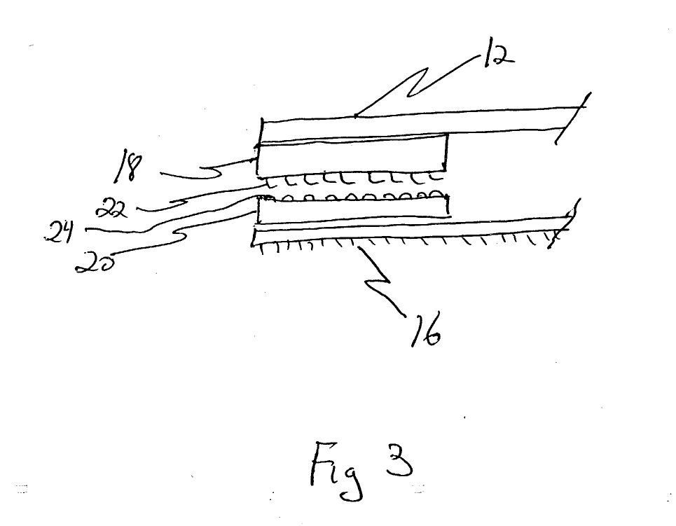

With reference to FIG. 2 shown is a cross-sectional view “a-a” of the rain shield/golf towel combination 10 depicting the rain shield top layer 12, the golf towel bottom layer 16, with the two layers attached to each other be means of velcro type loop lock closure means having mating surfaces 18 and 20, which provides the means of easily attaching and detaching the rain shield layer 12 and the towel layer 16.

With reference to FIG. 3 shown is an expanded cross-section of the attachment means used in the combination depicted in FIG. 1, showing a portion of the rain shield top layer 12, to which is affixed one half of the velcro type loop lock closure means 18. Also shown is a portion of the golf towel bottom layer 16, to which is affixed the mating half of the velcro type loop lock closure means 20.

The exposed surface of the top half of the mating velcro type loop lock closure means 18 is provided with a multiplicity of hook-like appendages 22 which engage the multiplicity of loops 24 provided on the exposed surface of the bottom half of the mating velcro type loop lock closure means.

It is contemplated that in addition to velcro type closure means other types of closure means may also be effectively employed to provide the necessary attachment means for the rain shield layer and the towel layer, which would also provide the necessary ease of attachment and detachment required in the combination of the present invention.

Other suitable attachment means include a series of snap type closures arranged at intervals along the perimeters of the rain shield layer and the golf towel layer, a continuous zipper type closure completely encircling the perimeter of the rain shield layer and the golf towel layer, a series of buttons and aligned button holes arranged at intervals along the perimeter of the rain shield layer and the golf towel layer, and other equivalent closure means.

While the dimensions of the combination rain shield/golf towel of the present invention are not critical, it is contemplated that the overall dimensions of the combination of the present invention will preferably be from about 15″ to about 24″ in width and from about 26″ to about 48″ in length. Typically the overall dimensions of the combinations of the present invention will correspond to the dimensions conventionally used for stand alone golf towels, however such overall dimensions may in fact be any suitable width and length which meet the needs or desires of the user. Preferably, the overall dimensions of the combination of the present invention will be about 20″ in width by about 40″ in length.

The material from which the golf towel layer of the combination of the present invention will be fabricated may be any toweling material from which conventional golf towels are typically made, including without limitation: cotton, cotton/polyester blends, nylon, nylon blends, micro fiber and other equivalent suitable toweling materials which provide the desired degree of absorbency and durability sought in a conventional golf towel.

The material from which the rain shield layer of the combination of the present invention will be fabricated may be any one of a number of available fabrics which are designed to shed water rather than absorb it, including without limitation: polyester fabrics, nylon fabrics, coated fabrics, multi-layered fabrics, and equivalent fabrics. Preferably, the rain shield layer of the combination of the present invention will be fabricated from a Gore-Tex type fabric which typically incorporates an expanded PTFE film which has been bonded to some other suitable fabric and which is known to possess superior rain shedding characteristics.

In all cases the fabric used for the rain shield layer of the combination rain shield and golf towel of the present invention must possess the necessary degree of flexibility and feel in order to allow the user the ability to utilize the combination as a golf towel when the two layers are attached under normal circumstances. Thus, the rain shield layer of the combination of the present invention cannot be unduly stiff or lack the ability to be easily folded or else its function as a golf towel will be impaired.

It is also contemplated that the combination of the present invention may be provided with one or more grommet holes located in one or more corners of the combination depending upon its size, for purposes of attachment of the combination to the golfer's golf bag or cart, as the user desires.

It will be further apparent to one skilled in this art that the improvements provided for in the present invention, while described with relation to certain specific physical embodiments also lend themselves to being applied in other physical arrangements not specifically provided for herein, which are nonetheless within the spirit and scope of the invention taught here.

I claim:

1. A multi-layered combination rain shield and golf towel comprising a conventional golf towel layer and a fabric layer which is capable of shedding rain, wherein said golf towel layer and said rain shedding fabric layer are attached along their respective perimeters by a means which permits the two layers to be easily detached.

2. A multi-layered combination rain shield and golf towel according to claim 1, wherein the means by which the two layers are attached is selected from the group comprising mating velcro type loop lock closure means arranged along the respective perimeter of the rain shield layer and the golf towel layer, a series of snap type closures arranged at intervals along the perimeters of the rain shield layer and the golf towel layer, a continuous zipper type closure completely encircling the perimeter of the rain shield layer and the golf towel layer, a series of buttons and aligned button holes arranged at intervals along the perimeter of the rain shield layer and the golf towel layer, and other equivalent closure means.

3. A multi-layered combination rain shield and golf towel according to claim 1, wherein the means by which the two layers are attached is a mating velcro type loop lock closure means arranged continuously along the respective perimeters of the rain shield layer and the golf towel layer.

4. A multi-layered combination rain shield and golf towel according to claim 1, wherein the combination has a width of from about 15″ to about 24″ and a length of from about 26″ to about 48″.

5. A multi-layered combination rain shield and golf towel according to claim 1, wherein the combination has a width of about 20″ and a length of about 40″.

6. A multi-layered combination rain shield and golf towel according to claim 1, wherein the golf towel layer is fabricated from a toweling material selected from the group comprising cotton, cotton/polyester blends, nylon, nylon blends, micro fiber and other equivalent suitable toweling materials which provide the desired degree of absorbency and durability sought in a conventional golf towel.

7. A multi-layered combination rain shield and golf towel according to claim 1, wherein the rain shield layer is fabricated from a fabric selected from the group comprising polyester fabrics, nylon fabrics, coated fabrics, multi-layered fabrics and equivalent fabrics which are designed to shed water rather than absorb it.

8. A multi-layered combination rain shield and golf towel according to claim 1, wherein the golf towel layer is fabricated from a cotton toweling material and the rain shield layer is fabricated from a Gore-Tex type fabric, which incorporates an expanded PTFE film which has been bonded to another fabric layer which is known to possess superior rain shedding characteristics.

9. A multi-layered combination rain shield and golf towel according to claim 1, wherein the combination is also provided with one or more grommet holes for attachment of the combination to the golfer's golf bag or golf cart.
